(19) United States
(12) Patent Application Publication
(10) Pub. No.: US 2014/0229209 A1
(43) Pub. Date: Aug. 14, 2014

(54) SYSTEMS AND METHODS OF GENERATING PRODUCT PACKAGES

(71) Applicants: Marko Thomas Greisen, Las Vegas, NV (US); Jennifer Lee Carrico, Atherton, CA (US)

(72) Inventors: Marko Thomas Greisen, Las Vegas, NV (US); Jennifer Lee Carrico, Atherton, CA (US)

(21) Appl. No.: 14/180,846

(22) Filed: Feb. 14, 2014

Related U.S. Application Data
(60) Provisional application No. 61/764,945, filed on Feb. 14, 2013.
(60) Provisional application No. 61/785,440, filed on Mar. 14, 2013.

(51) Int. Cl. G06Q 30/02; G06Q 10/02; G06Q 30/06

(52) U.S. Cl. CPC G06Q 30/0283; G06Q 30/0601; G06Q 10/02
USPC 705/5; 705/26.1

(57) ABSTRACT

Methods and systems to generate product packages are provided. A first request to include a first item in a package is received from a device, where the first item is associated with a first price. The package is purchasable by a user of the device. An original package price associated with the package is calculated in response to receiving the first request and is provided to the device, where the original package price includes the first price. A second request to include a second item in the package is received, where the second item is associated with a second price. An adjusted package price is calculated in response to receiving the second request and is provided to the device, where the adjusted package price is less than a sum of the first and second price and includes a discount of the first price and a discount of the second price.

### CROSS-REFERENCE TO RELATED APPLICATIONS

This application claims a priority benefit of U.S. Provisional Application No. 61/764,945, filed Feb. 14, 2013, entitled “Systems and Methods of Generating Travel Packages,” which is incorporated herein by reference in its entirety.

This application also claims a priority benefit of U.S. Provisional Application No. 61/785,440, filed Mar. 14, 2013, entitled “Systems and Methods of Generating Product Packages,” which is incorporated herein by reference in its entirety.

### TECHNICAL FIELD

The present disclosure generally relates to electronic commerce and, more specifically, to systems and methods of generating product packages.

### BACKGROUND

An online commerce environment may allow a user to purchase a product and/or service online. In some online commerce environments, the products or services offered may come from more than one supplier of the product or service.

### BRIEF DESCRIPTION OF THE DRAWINGS

Some embodiments are illustrated by way of example and not limitation in the figures of the accompanying drawings.

FIG. 1 is a schematic diagram showing an example of a system for generating product packages, according to some embodiments;

FIGS. 2A-2C are flowcharts showing example methods of generating product packages, according to some embodiments;

FIGS. 3A-3B are interface diagrams illustrating example user interfaces for initiating a purchase of a package, according to some embodiments;

FIGS. 4A-4C are interface diagrams illustrating example user interfaces for adding an item to a package, according to some embodiments;

FIGS. 5A-5B are interface diagrams illustrating example user interfaces for including details associated with an item to be added to a package, according to some embodiments;

FIGS. 6A-6B are interface diagrams illustrating example user interfaces confirming an addition of an item to a package, according to some embodiments;

FIGS. 7A-7B are interface diagrams illustrating example user interfaces for adding a subsequent item to a package, according to some embodiments;

FIGS. 8A-8B are interface diagrams illustrating example user interfaces for including details associated with a subsequent item to be added to a package, according to some embodiments;

FIGS. 9A-9B are interface diagrams illustrating example user interfaces notifying a user of package savings provided in response to a subsequent item added to a package, according to some embodiments;

FIGS. 10A-10B are interface diagrams illustrating example user interfaces displaying the contents of a package, according to some embodiments;

FIG. 11 is an interface diagram illustrating an example user interface for adding a subsequent item to a package, according to some embodiments;

FIG. 12 is a flowchart of an example method for generating product packages, according to some embodiments; and

FIG. 13 is a block diagram of a machine in the example form of a computer system within which a set of instructions, for causing the machine to perform any one or more of the methodologies discussed herein, may be executed, according to some embodiments.

### DETAILED DESCRIPTION

Example systems and methods to generate product packages are described. In the following description, for purposes of explanation, numerous specific details are set forth in order to provide a thorough understanding of example embodiments. It will be evident, however, to one skilled in the art that the present technology may be practiced without these specific details.

The technology disclosed herein relates in general to packaging products available for purchase. In some specific examples, booking and reservation systems and methods for travel items are disclosed. The technology allows a customer to access a central reservation system through any type of browser (e.g., Internet Explorer, Firefox, Chrome, Safari, etc.) or an application to package or bundle travel items (e.g., lodging, flights, tours, shows, activities, etc.) from any number of suppliers of travel items. These travel items may be packaged in any combination using a central reservation system that manages items available from suppliers. Packaging the travel items provides a cheaper price on the items collectively through opaque wholesale pricing. While some examples disclosed herein describe packaging of travel items, one of ordinary skill in the art will recognize that any type of item (e.g., products, services, etc.) from any type of supplier may be packaged using any of the packaging techniques disclosed herein.

Suppliers of these travel items (e.g., lodging companies such as hotels, motels, timeshares, rental properties, shows, tours, activities, etc.) may access a content management system (CMS) associated with the central reservation system to manage the items they wish to make available for sale. The CMS may be accessible to suppliers via an extranet that provides access to the CMS, and the CMS may manage and store information associated with travels items, such as content, pricing, and the like, and the central reservation system may access information from the CMS and present the information to customers. In some embodiments, suppliers may use the CMS associated with the central reservation system to specify preferred travel products from other suppliers to be packaged with their products. For example, a hotel may have a relationship (e.g., partnership) with another travel company, and the hotel may specify travel items from that travel company to be packaged in addition to booking the accommodation. Information for travel items may be provided from suppliers to the central reservation system using user interfaces associated with the extranet, which allows suppliers to input information for travel items. The information from suppliers may be entered into the CMS associated with the central reservation system using the user interfaces, or the information may be retrieved from the suppliers' systems using an application programming interface (API). For example, suppliers may use the user interfaces to provide any information relevant to the travel items, such as pricing data (e.g., retail prices, wholesale costs, package prices, discounts, etc.), product descriptions, policies, images, video, captions, media, product names, sub-product names, ticket types, product categories, policies associated with the travel item, a subheading, filter option, location of the travel item, date and time of events, publish date, timing for offers, and the like. In some embodiments, the user interfaces provided to suppliers may allow suppliers the flexibility to input as much or as little information as they wish and may provide for greater control of the suppliers' brands. Suppliers may provide payment to the central reservation system via the extranet associated with the central reservation system in any suitable form of payment, where the payment may be based on any appropriate factors. For example, a supplier may provide payment based on a fixed (e.g., wholesale) price of the travel items provided on the central reservation system, based on a subscription price, based on the number of travel items sold, and the like.

A travel package may contain any number and combination of travel items from any number and combination of suppliers. As used herein, a “package” refers to a customizable product which may be purchased in a single transaction by a user for a particular price and may include one or more travel items. A travel item may be any item available for purchase and may be associated with travel events such as lodging, flights, car rentals, shows, concerts, tours, reservations, nightlife events, and the like. An individual travel item may be associated with a particular retail price. A user may use the central reservation system to build a customized package containing one or more travel items provided by suppliers. As the user adds items to the package, the price of the package as a whole may be dynamically calculated and discounted based on a package pricing algorithm. The package pricing algorithm may be used to calculate the price of the package based on any suitable factors, such as the number of items the user adds to the package, the type of items added to the package, the combination of items in the package, arbitrarily chosen discounts, and the like. For example, when a user adds a first item to the package, the price of the package may be equal to the retail price of that first item (e.g., 0% discount on the price of the package). When a user adds a second item to the package, the price of the package as a whole may be discounted such that the price of the package is less than the sum of the retail prices for the first and second items (e.g., 10% discount on the price of the package). As the user adds more items to the package, the discount rate for the package may increase (e.g., 10% discount for 2 items, 15% discount for 3 items, etc.). Allowing for pricing of packages in an opaque manner limits exposure of the discounted prices for each travel item, which may be beneficial to suppliers who wish to aggressively price their items without devaluing their brand.

While examples described herein refer to packaging of travel items, one of ordinary skill in the art will recognize that the techniques described for packaging products may be utilized for any type of item, product, service, and the like. For example, any product available for purchase may be packaged or bundled with one or more other products from the same or from a different supplier, where the packaged price may be calculated and/or adjusted based on the items, products, services, and the like, in the package (e.g., based on the number of items, products, services, etc. in the package).

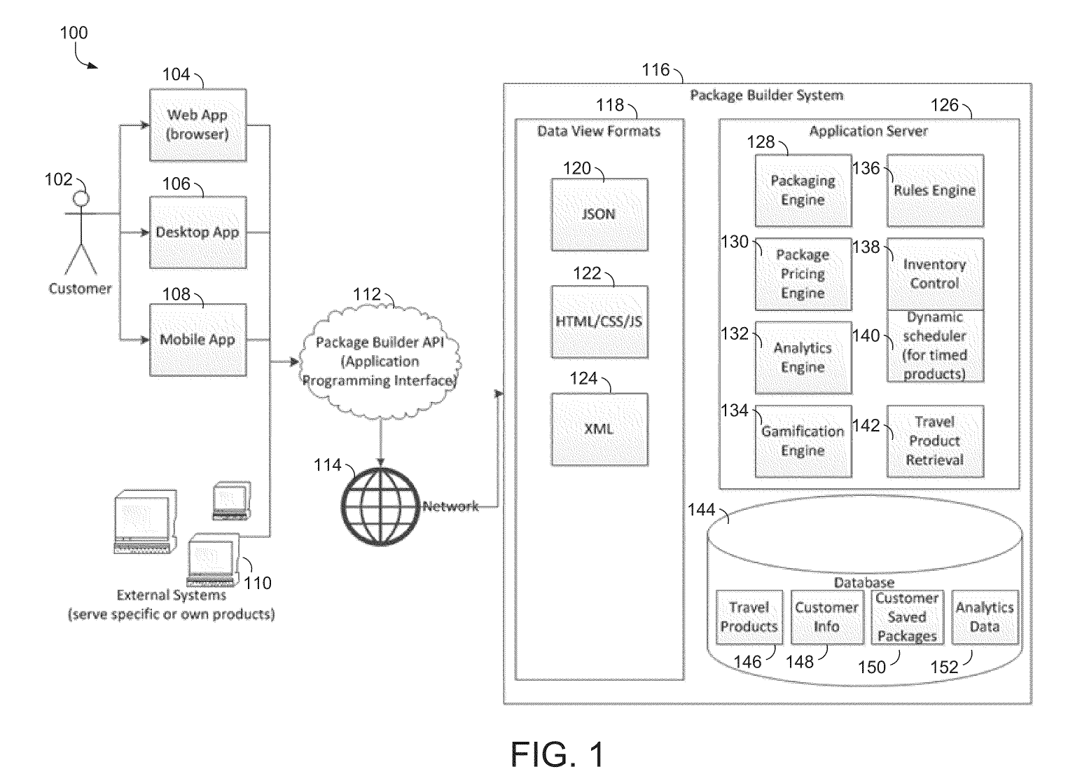

FIG. 1 is a schematic diagram showing an example of a system 100 for generating product packages. In the system 100, a customer 102 may access a central reservation system such as the package builder system 116. The package builder system 116 may be accessed by the customer 102 through any appropriate client device of the customer 102 using any appropriate application accessible through the client device, such as a web application 104 (e.g., a browser), a desktop application 106, a mobile application 108, and the like. For example, the customer 102 may access the package builder system 116 through a website managed by the package builder system. The customer 102 may use any suitable computing device to access the package builder system 116, such as a smart phone, personal digital assistant, mobile phone, personal computer, a laptop, a computing tablet, and the like. The package builder system 116 may be accessed over a network 114 using any suitable APIs 112. In some embodiments, one or more portions of the network 114 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The system 100 may also include network-addressable external systems 110, which may be any number of systems managed by any number of suppliers of travel items. A supplier may set up an account with the package builder system 116 by providing any relevant supplier information (e.g., supplier name, address, phone number, supplier web address, email, contact person, supplier code, etc.). Once the account is set up, the external systems 110 of the suppliers may access the package builder system 116 through any suitable application (e.g., web application, desktop application, mobile application) using the network 114. The external systems 110 may manage information associated with travel items available for purchase. Information associated with travel items may be submitted to the package builder system 116 by inputting the information to the package builder system 116, or the package builder system 116 may access the information using APIs, such as APIs 112. Additionally, suppliers may receive supplier notifications at the external systems 110 in any manner (e.g., email, fax, etc.), such as notifications relating to receiving a reservation from a customer, payment processing options, terms and conditions relating to the payment process, and the like.

The package builder system 116 may be a network-addressable system that may manage, control, store, and present any information associated with travel items available for purchase. The package builder system 116 may be able to receive information associated with travel items and provide the information over the network 114 in any suitable data format. The data view formats 118 may manage conversions of information between different formats such as JavaScript Object Notation (JSON) 120, HyperText Markup Language (HTML), Cascading Style Sheets (CSS), JavaScript (JS) 122, Extensible Markup Language (XML) 124, and the like.

The package builder system 116 may store any information in database 144, such as information relating to travel products or items 146, customer information 148, customer saved packages 150, analytics data 152, and the like. The customer information 148 may include any information associated with or identifying a customer, preferences of the customer, account information of the customer, and the like. The customer saved packages 150 may include any information associated with packages a customer has built and saved. In some embodiments, details of saved packages may be sent to another person if the customer request that the details be sent (e.g., can email the details of a package to a friend). Analytics data 152 may include any information associated with the package builder system 116 that has been analyzed. For example, the analytics data 152 may include information associated with an analysis of user traffic, revenue, product and supplier-specific sales details, popular travel items, and the like.

The application server 126 of the package builder system 116 may manage and control the applications used by customer 102 and external systems 110 to access and send information associated with travel items.

The packaging engine 128 of the application server 126 may manage and control the dynamic building of packages. The packaging engine 128 may access information associated with travel products 146, present the information to the customer, and facilitate the building of a package as the customer builds the package.

The package pricing engine 130 of the application server 126 may calculate a package price for a package built by a customer. The package pricing engine 130 may calculate the package price based on any pricing algorithm, such as calculating the package price based on the number and type of travel items included in the package, any associated deals or discounts available for the travel items in the package, and the like.

The analytics engine 132 of the application server 126 may perform any relevant analysis on information received at the package builder system 116 and store the analytics data 152 in the database 144.

The gamification engine 134 of the application server 126 may provide any relevant features to the customer in such a manner that engages the customer.

The rules engine 136 of the application server 126 may manage and control rules associated with how a package may be built.

The inventory control 138 of the application server 126 may manage and control the inventory of the travel products 146 available for purchase based on what is received from suppliers and what is sold to customers. The inventory control 138 may update the travel products 146 in the database 144 according to customer and supplier activity.

The dynamic scheduler 140 of the application server 126 may manage and control the availability and presentation of travel items that may be time-sensitive. For example, if a particular price for a hotel room is being offered for the next two days, the dynamic scheduler 140 may manage and control the timing of the offered price such that the offered price becomes unavailable to customers after the two days has passed.

The travel product retrieval 142 of the application server 126 may retrieve any relevant travel products 146 available for purchase upon a request from a customer. For example, if a customer is searching for a ticket to a show on a particular date, the travel product retrieval 142 may retrieval any relevant information about shows for that particular date. The requested information may then be presented to the customer.

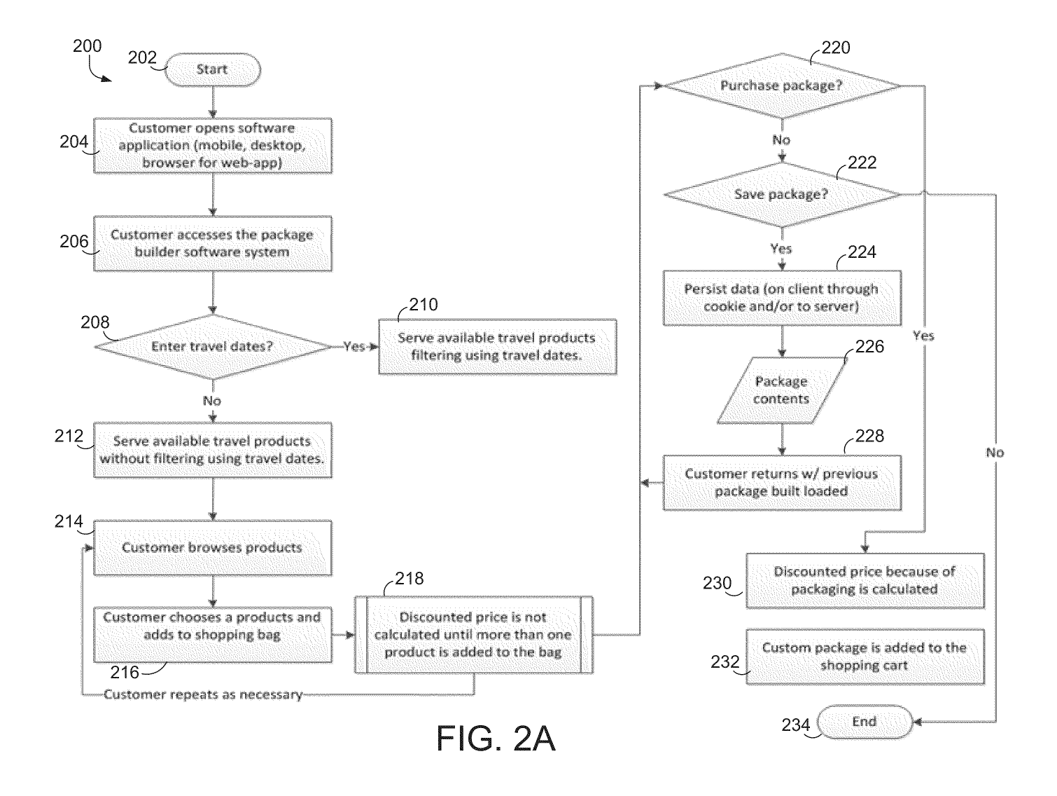

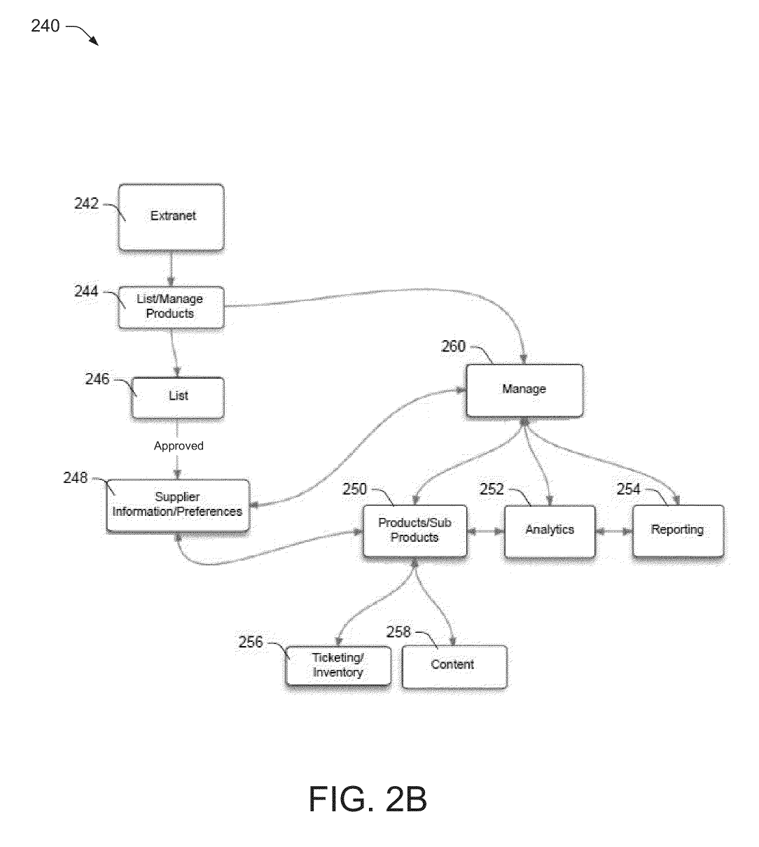

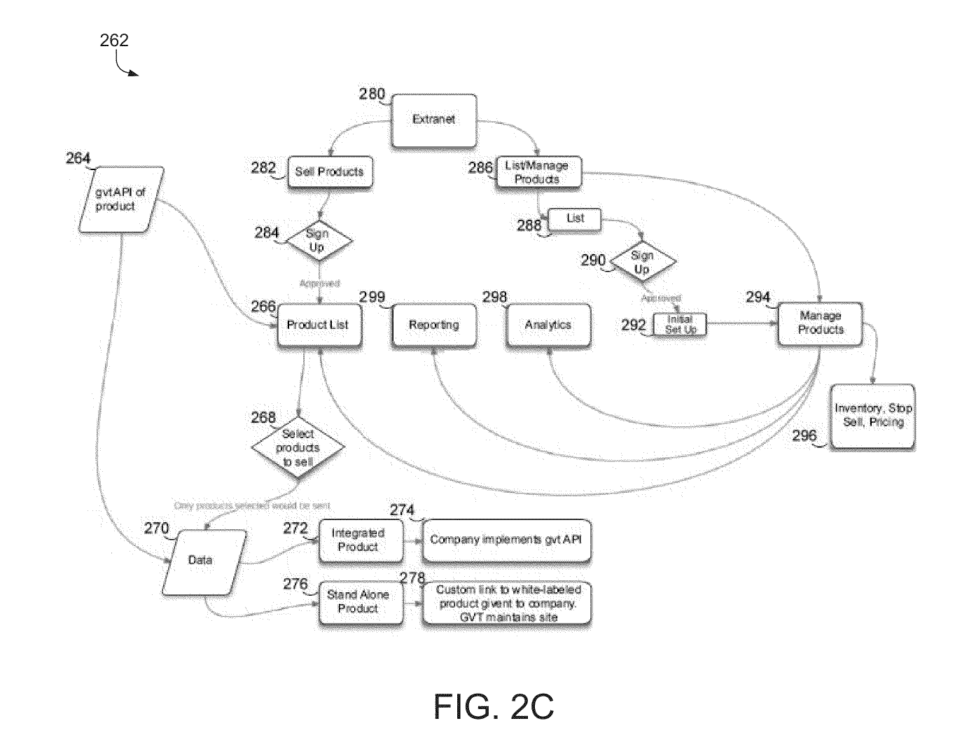

FIGS. 2A-2C are flowcharts showing example methods 200, 240, and 262 of generating product packages. FIG. 2A shows a method 200 of generating a travel package in response to a user request to build and purchase a package.

When method 200 starts at operation 202, the customer may open the software application associated with the package builder system (operation 204).

In operation 206, the customer may access the package builder software system available through the software application.

In operation 208, the customer may have the option of entering travel dates or other relevant dates associated with the package the customer would like to build.

In operation 210, if the customer enters a relevant date or range of dates, any available travel items associated with those dates may be presented to the customer.

In operation 212, if the customer does not enter any date information, the customer may be presented with any number of available travel items that the customer may purchase, regardless of the date associated with those travel items.

In operation 214, the customer may browse the travel items presented to the customer.

In operation 216, the customer may choose a travel item and add that item to the package.

In operation 218, if more than one travel item is included in the package, the package builder system may calculate the discounted price of package. The discounted price may be calculated using any appropriate package pricing algorithm which may take into account any suitable factors (e.g., number of items, type of items, combination of items, customer loyalty programs, special promotions, etc.). In some embodiments, the discounted price may be a price that is discounted at a particular percentage. If only one travel item is included in the package, the price of the package may be a non-discounted price of the travel item. The customer may repeat operations 214, 216, and 218 until the customer is satisfied with the travel items in the package.

In operation 220, the package builder system may ask the customer whether the customer would like to purchase the package that was built. If the customer chooses not to purchase the package at that time, the package builder system may ask the customer whether the customer would like to save the package so that the package may be purchased later (operation 222). If the customer chooses not to save the package, the process may end at operation 234 and the package will not be saved or purchased.

In operation 224, if the customer chooses to save the package, the information associated with the package and its contents will be stored on the package builder system and relevant data that may be used to access the stored package may be stored on the client device of the customer (e.g., cookie).

In operation 226, the package and the travel items in the package may be associated with each other.

In operation 228, when the customer returns to the package builder application, the saved package may be automatically presented to the customer. The customer may then be asked whether the customer would like to purchase the package (operation 220).

In operation 230, when the customer is ready to purchase a package that has been built, the price of the package may be calculated, which may include a discount if the package includes more than one travel item.

In operation 232, the custom package may be added to the customer's shopping cart, and the customer may subsequently pay for the package.

FIG. 2B shows a method 240 of managing and providing supplier-provided information for travel items. In operation 242, a supplier administrative extranet may be provided to a supplier. The extranet may allow a supplier to manage and list information associated with travel items provided by the supplier (operation 244), which may or may not be approved by the extranet. The list may be presented to the supplier (operation 246), and the supplier may then specify information or preferences for surfacing the travel item information to customers (operation 248).

In operation 260, the package builder system may manage the information received from the supplier through the extranet. The package builder system may manage any preference or information specified by the supplier in operation 248, products and sub-products provided by the supplier in operation 250, any analytics associated with the supplier and the supplier's products in operation 252 (e.g., analytics on information such as frequency of supplier's items being clicked on, items added to a user's cart, etc.), any information to be reported to the supplier in operation 254, and the like. In some embodiments, the analytics information may be used to recommend other products that are related to the user's interests based on the user's behavior. The products and sub-products may be managed and presented to customers in a manner specified by the supplier information and/or preferences and may include ticketing and inventory information (operation 256) and other travel item content (operation 258).

FIG. 2C shows a method 262 of managing supplier-provided information associated with travel items. The method 262 allows the supplier-provided information to be pulled from the supplier externally through an API. In operation 264, the information associated with travel items may be pulled from the supplier's system using an API. That information may be integrated into a product list (operation 266), and the supplier may specify which products to offer for sale to customers (operation 268). The data associated with products that may be made available for sale may be stored (operation 270). The data for the available travel items may be integrated with other products (operation 272) from other companies, which may also have data pulled from their systems using an API (operation 274). In some embodiments, the data associated with products that may be made available for sale may be sold as stand-alone products (operation 276) (e.g., a white-labeled product branded by an entity that is a third-party to the package builder system), and a custom link may be provided to the supplier (operation 278).

When the extranet is accessed by a supplier (operation 280), the extranet may allow a supplier to sell products (operation 282), sign up for services available to suppliers through the package builder system (operation 284). Once the supplier is approved, the product list with the supplier's travel items may be provided to the supplier (operation 266).

The extranet may also allow suppliers to list and manage products (operation 286), which may be presented to the supplier (operation 288). The supplier may sign up for services with the package builder system (operation 290). Once the supplier is approved, the supplier's account may be set up (operation 292), and the supplier may begin managing the supplier's travel items (operation 294). Managing the supplier's products may include managing inventory, managing whether to stop selling or start selling a particular travel item, managing pricing for travel items, and the like (operation 296). Additionally, the supplier may perform analytics on information associated with the supplier and the supplier's sales (operation 298). The supplier may also receive reports that the supplier indicates the supplier would like to receive (operation 299).

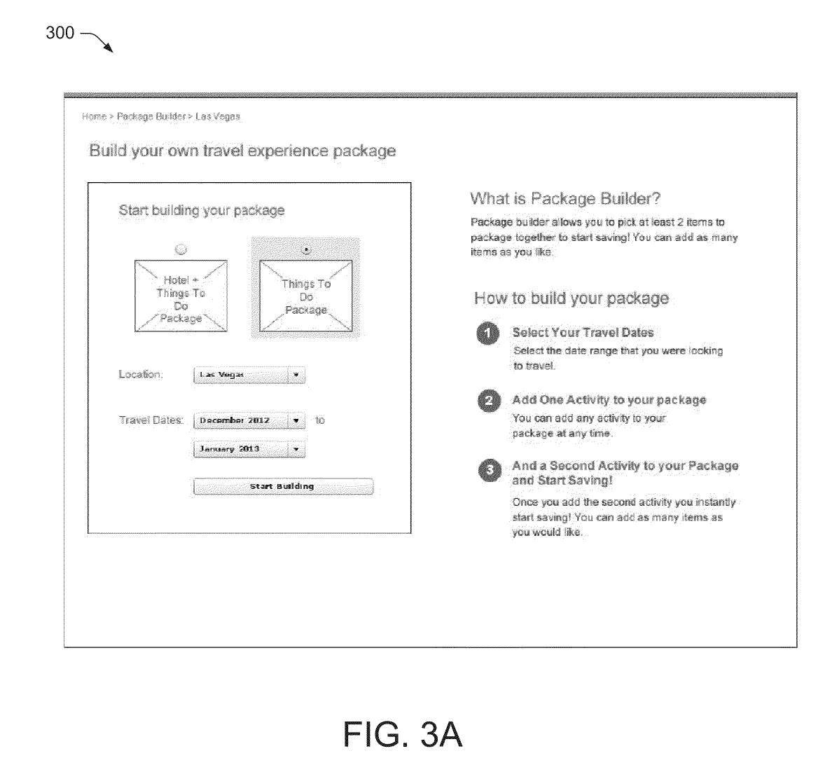

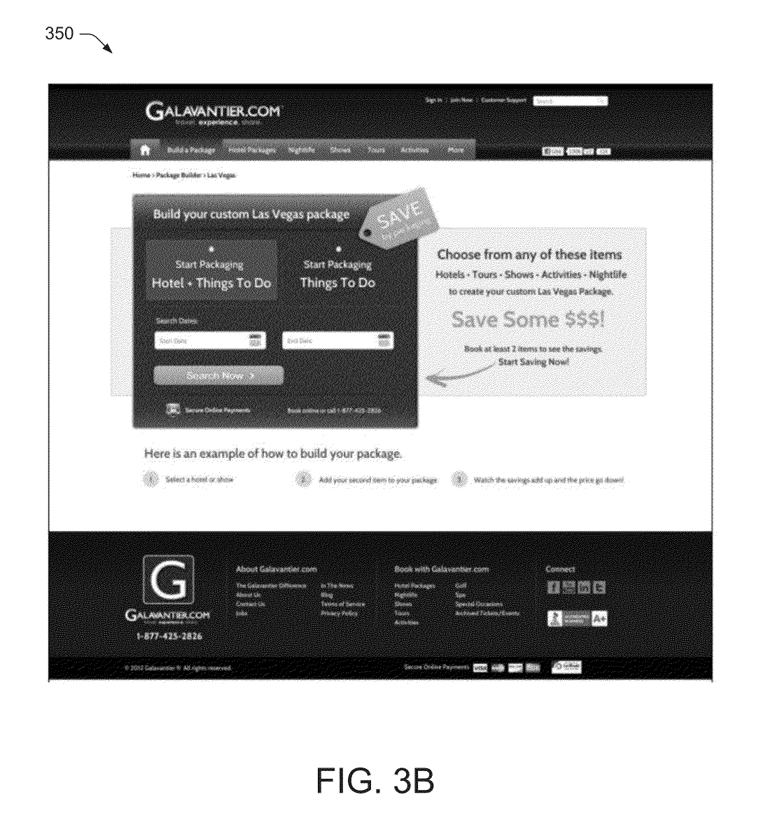

FIGS. 3A-3B are interface diagrams illustrating example user interfaces 300 and 350 for initiating a purchase of a package. In FIG. 3A, user interface 300 shows what a user may see upon initiating an application associated with the package builder system. The user may select the type of package that the user may want to build. In some embodiments, the user may begin creating a package that includes activities and hotel accommodations, or the user may begin creating a package that only includes activities. The user may specify one or more locations for the travel items in the package, relevant dates for the package, and the like. For example, if a user is planning a trip involving multiple cities, the user may specify the cities for which the user would like to view travel items. In some embodiments, a user may set up an account with the package builder system, or a user may first log into an existing account the user has with the package builder system. The account may be customized by the user, such that the user may specify user preferences, access purchase history, access saved packages, and the like.

The user interface 350 of FIG. 3B similarly shows what a user may see upon initiating an application associated with the package builder system. User interface 350 allows a user to select the type of events the user may include in the package and relevant dates for the events.

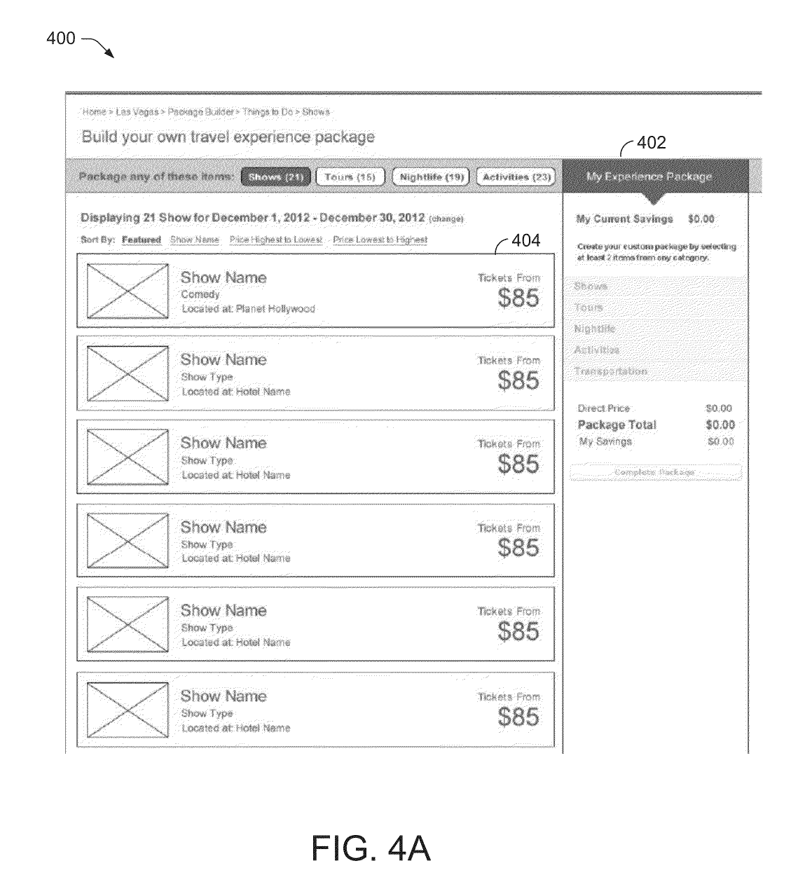

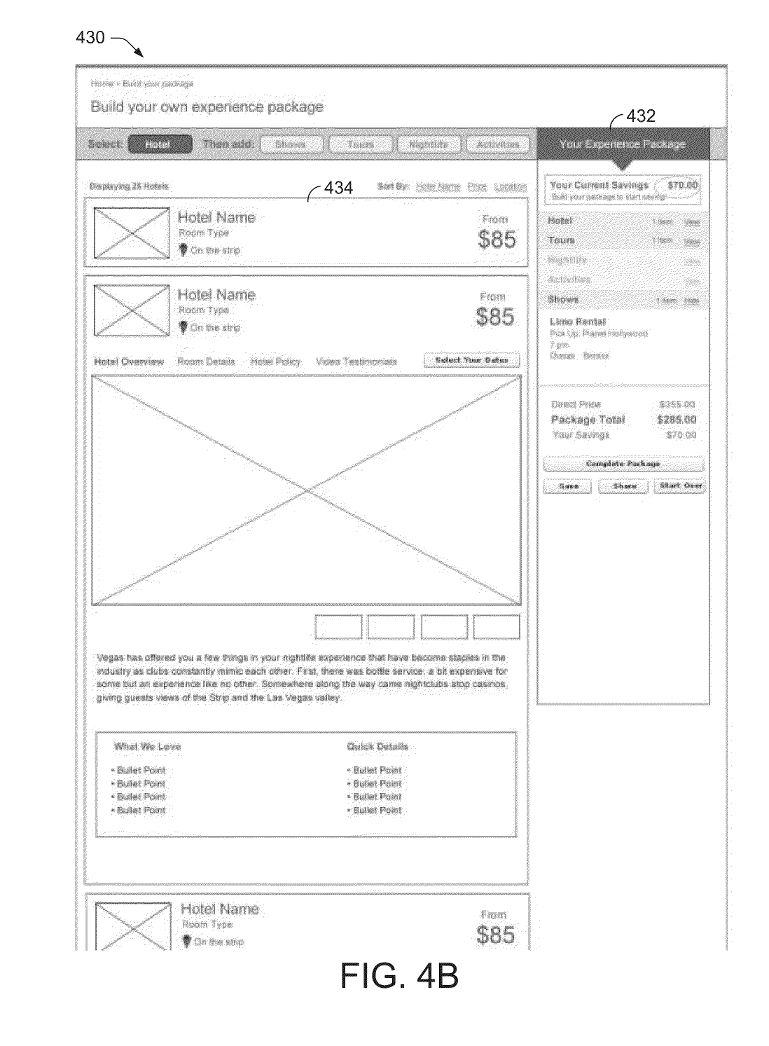

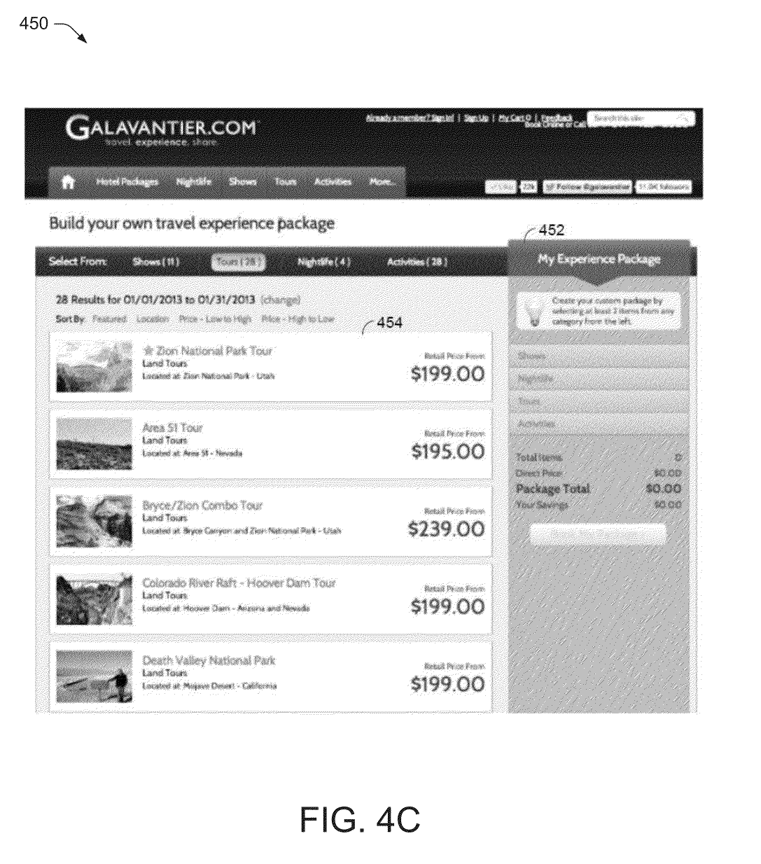

FIGS. 4A-4C are interface diagrams illustrating example user interfaces 400, 430, and 450 for adding an item to a package. In FIG. 4A, the user interface 400 shows a list of relevant travel items retrieved (e.g., travel item 404) based on the information provided when the application was initiated (e.g., using the user interfaces 300 and 350 of FIGS. 3A-3B). The user interface 400 may also show prices for the travel items retrieved. In some embodiments, the package builder system may determine the user's current location at the time the package is being built, and the package builder system may present a list of travel items that are relevant to the place and/or time the user is building the package. Each of the items in the list of travel items may be displayed in a manner that may be specified by the supplier of the item (e.g., brand logo, images, descriptions, titles, etc.). The user interface 400 may include a side portion 402 that indicates the travel items currently in the package. In some embodiments, the side portion 402 may continually be displayed to the user, even if the user scrolls down the page.

The user interface 430 of FIG. 4B may similarly display a list of travel items (e.g., travel item 434 being a hotel item) and a side portion 432 indicating the travel items currently in the package.

The user interface 450 of FIG. 4C may similarly display a list of travel items (e.g., travel item 454) and a side portion 452 indicating the travel items currently in the package.

In some embodiments, the package builder system may determine that the user is a preferred customer or part of a loyalty program associated with the package builder system. The user may be a preferred customer or part of a loyalty program for any reason (e.g., user signed up for the program, user paid a premium or a subscription price to be a preferred customer, the user is a preferred customer based on the frequency at which the user purchases packages, etc.). In some embodiments, the package builder system may manage tiers or levels of users that are preferred customers or part of a loyalty program. The tiers or levels may be based on any number of factors (e.g., premium price paid, subscription price paid, frequency of use, etc.). If the user is a preferred customer or part of a loyalty program, the user may be presented with travel items (e.g., travel items 404 and 454) at prices that are cheaper than the prices offered to non-preferred customers or non-members of the loyalty program, which in some embodiments may be based in part on the tier or level of the user.

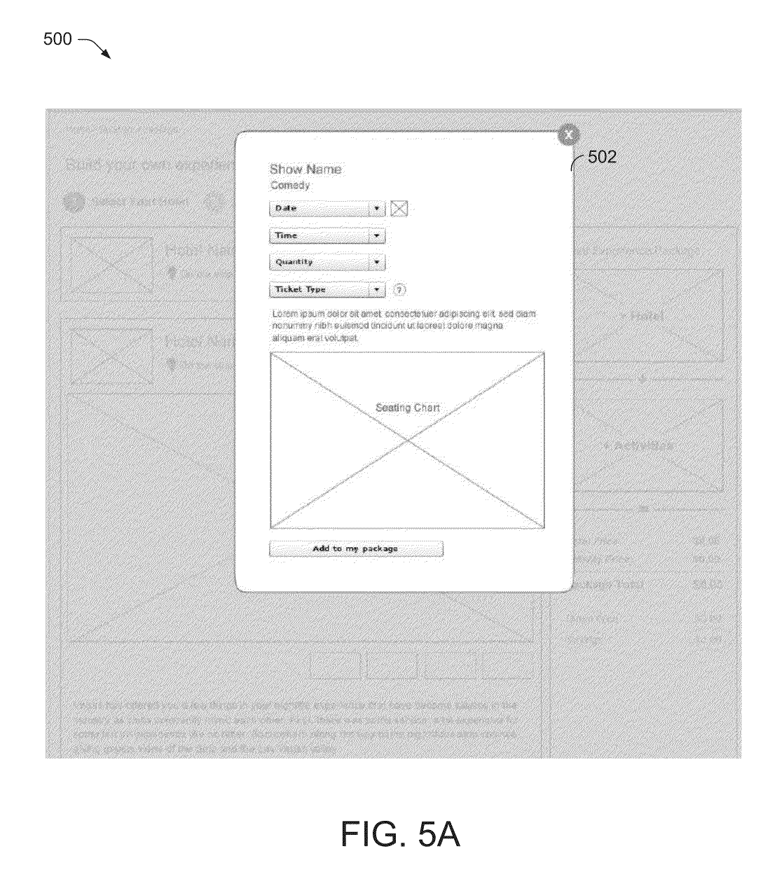

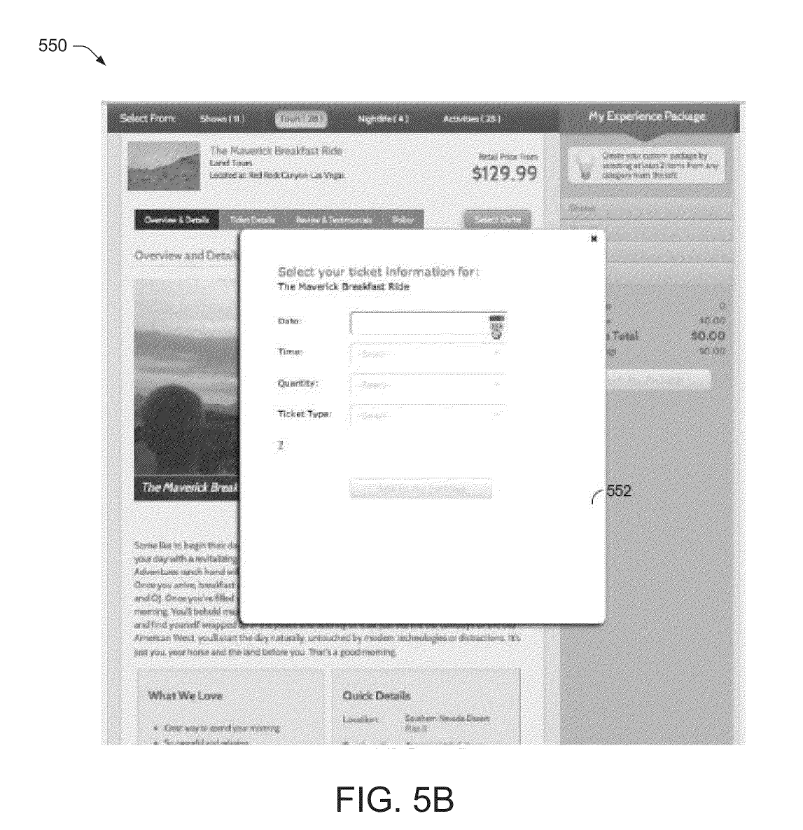

FIGS. 5A-5B are interface diagrams illustrating example user interfaces 500 and 550 for including details associated with an item to be added to a package. The user interface 500 of FIG. 5A includes a window 502 that may appear when a user selects a travel item from the list of travel items presented to the user in FIGS. 4A-4B. The window 502 may allow a user to provide details about the travel item selected, such as a date and time for the travel item, the number of tickets to be purchased, the type of ticket to be purchased, the seats that the user would like to purchase, and the like. The user interface 550 of FIG. 5B may similarly display a window 552 allowing a user to provide details for a selected travel item. Although windows 502 and 552 are shown in FIGS. 5A-5B and throughout the examples described in the Detailed Description, one of ordinary skill in the art will appreciate that the information conveyed in windows 502 and 552 may be conveyed in any suitable manner using windows or without using windows (e.g., within a webpage).

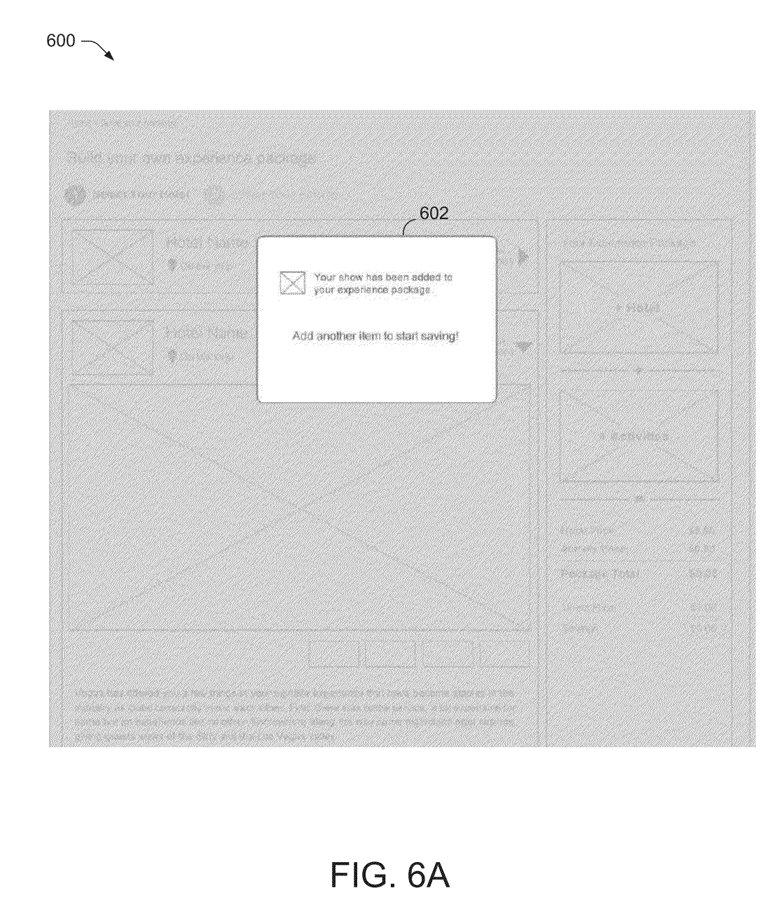

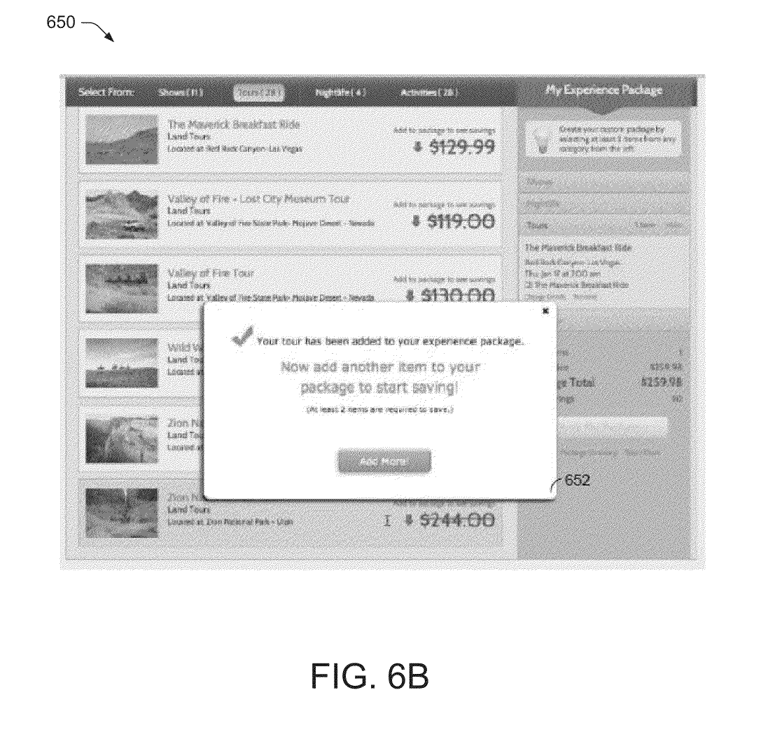

FIGS. 6A-6B are interface diagrams illustrating example user interfaces 600 and 650 confirming an addition of an item to a package. User interface 600 of FIG. 6A may include a window 602 which indicates that the selected travel item has been added to the package. The user interface 650 of FIG. 6B may similarly display a window 652 indicating that the selected travel item has been added to the package.

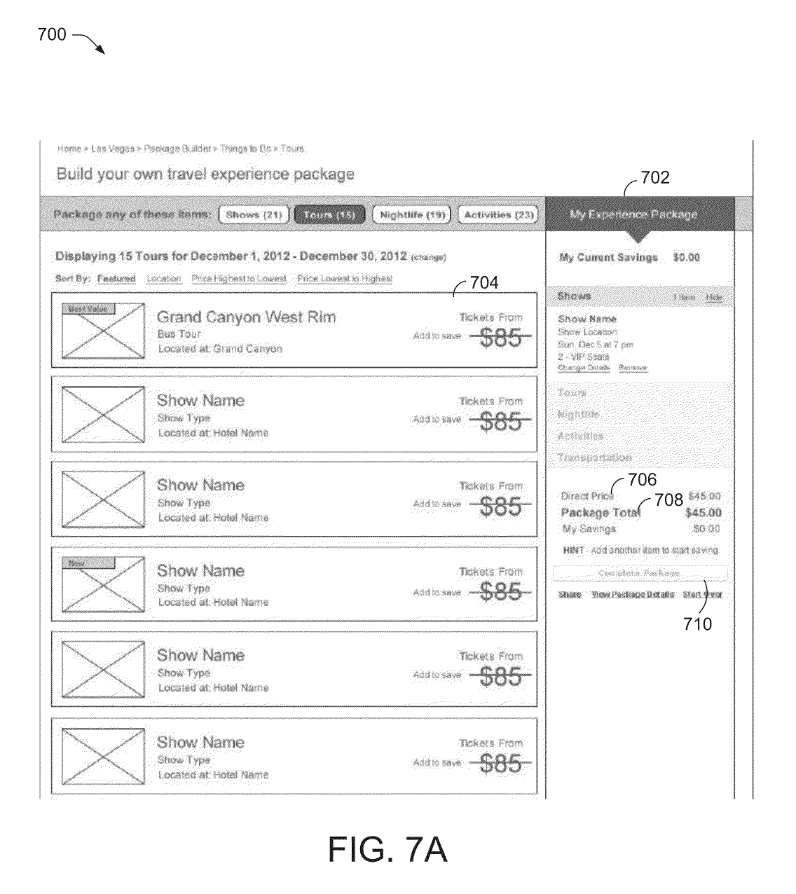

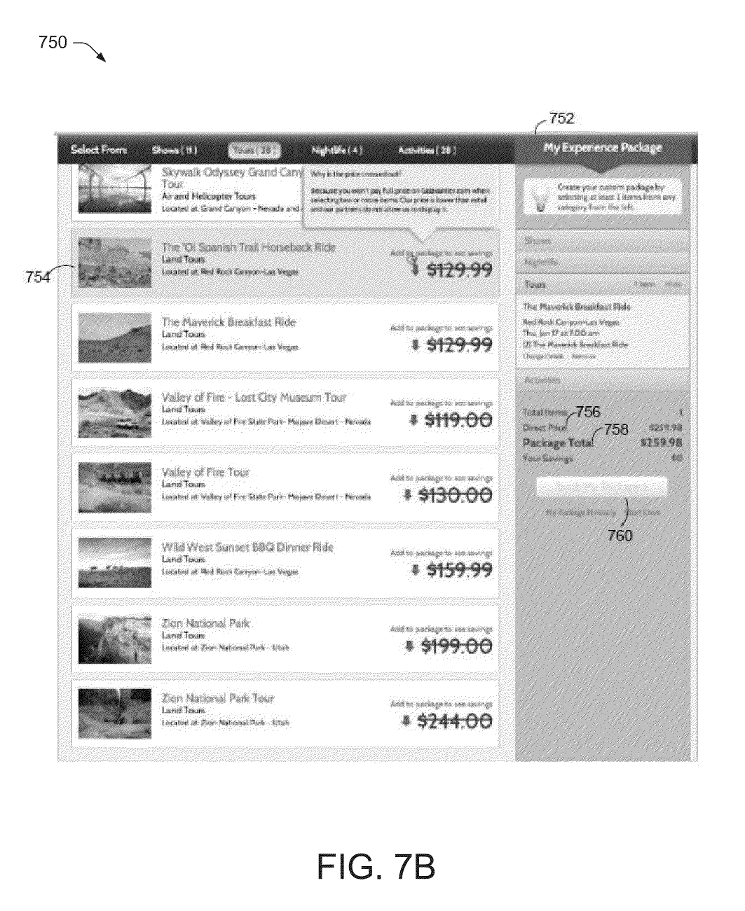

FIGS. 7A-7B are interface diagrams illustrating example user interfaces 700 and 750 for adding a subsequent item to a package. User interface 700 of FIG. 7A may include a list of travel items (e.g., travel item 704) that the user may add to the existing package. The prices for the travel items may be crossed out if the package already includes at least one other travel item. The crossed-out price indicates that the travel item may be added to the package for a price that is lower than the originally offered price.

The user interface 700 may also include a side portion 702 which may include details of the current package (e.g., the direct price 706, the package total 708, etc.). The side portion 702 may also include a button 710, which when selected by a user may initiate calculation of the package price.

User interface 750 of FIG. 7B may similarly include a list of travel items (e.g., travel item 754), where the travel items may be displayed with a crossed-out price. The user interface 750 may also include a side portion 752 indicating details of the current package (e.g., direct price 756, package total 758, etc.) and allowing the user to book the package using button 760. The side portion 752 may also allow a user to click on links to change or remove items currently in the package.

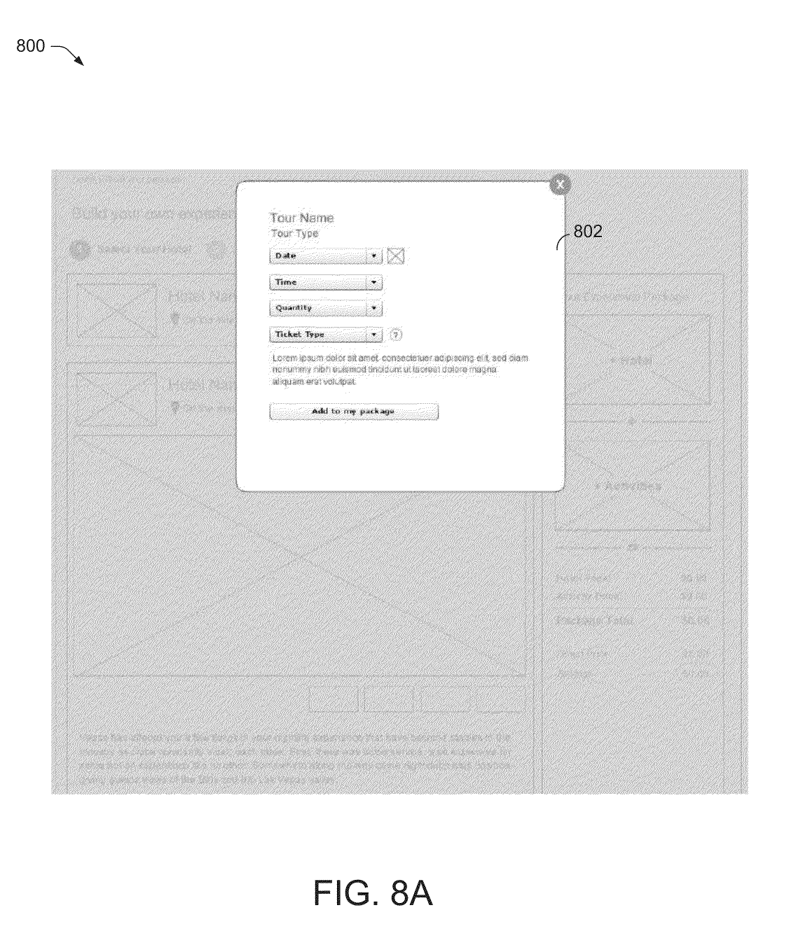

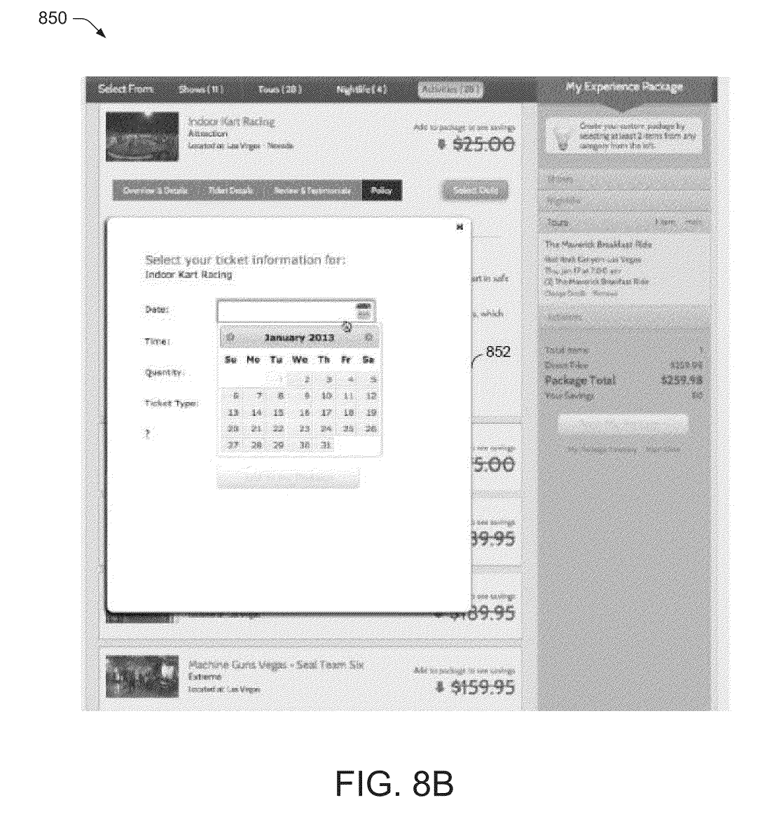

FIGS. 8A-8B are interface diagrams illustrating example user interfaces 800 and 850 for including details associated with a subsequent item to be added to a package. The user interface 800 of FIG. 8A includes a window 802 that may appear when a user selects a travel item from the list of travel items presented to the user in FIGS. 7A-7B. The window 802 may allow a user to provide details about the travel item selected, such as a date and time for the travel item, the number of tickets to be purchased, the type of ticket to be purchased, the seats that the user would like to purchase, and the like. The user interface 850 of FIG. 8B may similarly display a window 852 allowing a user to provide details for a selected travel item.

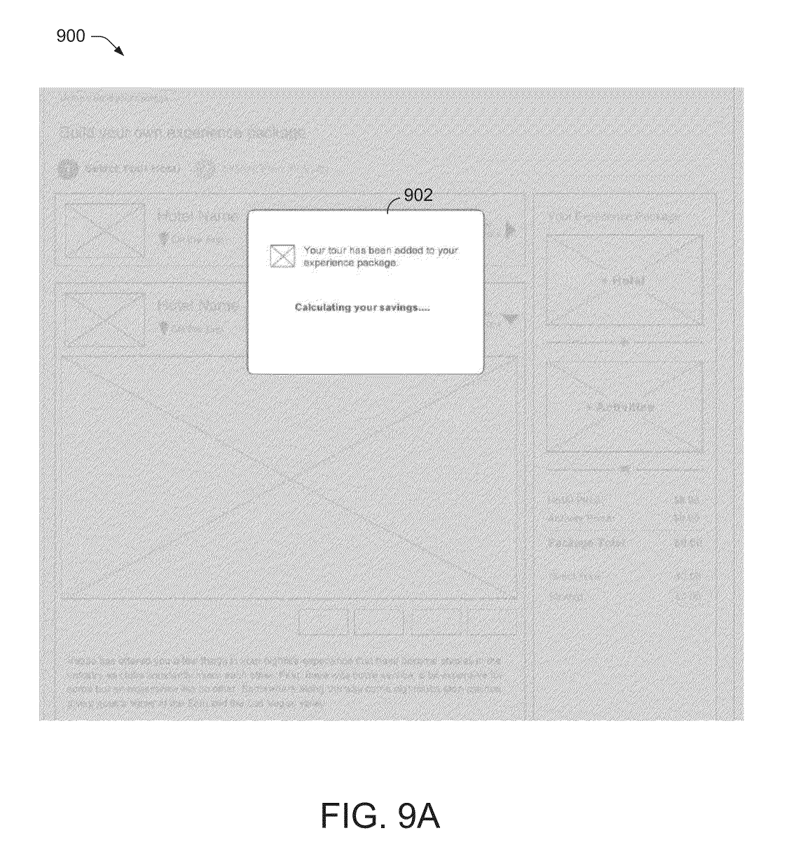

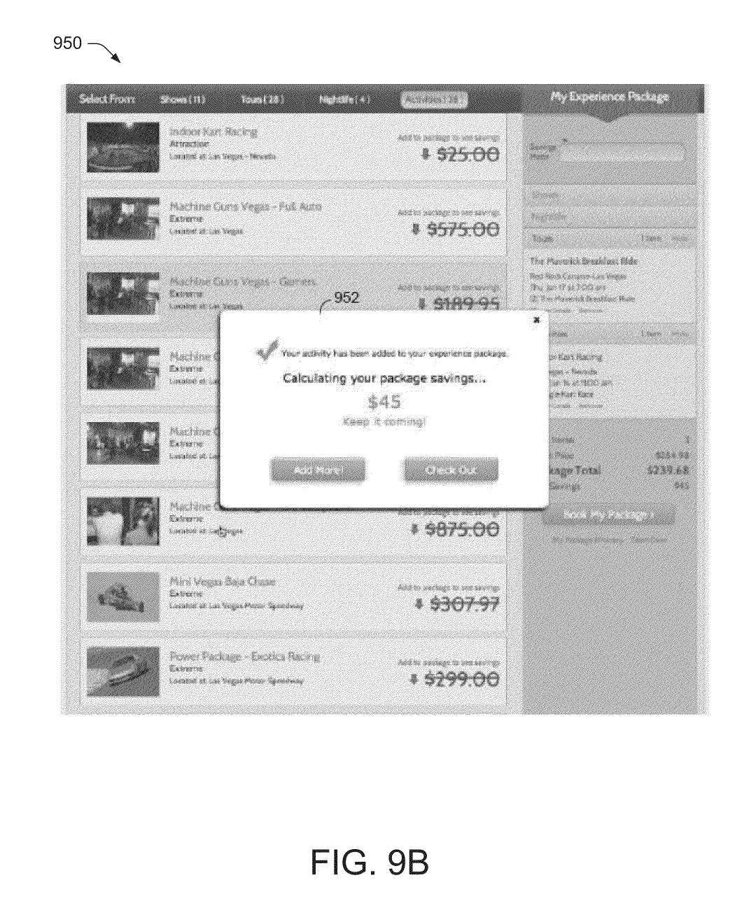

FIGS. 9A-9B are interface diagrams illustrating example user interfaces 900 and 950 notifying a user of package savings provided in response to a subsequent item added to a package. User interface 900 of FIG. 9A may include a window 902 which indicates that the selected travel item has been added to the package. The window 902 may also indicate that the package savings are being calculated based on the items in the package. The user interface 950 of FIG. 9B may similarly display a window 952 indicating that the selected travel item has been added to the package. The window 952 may indicate that the packages savings are being calculated based on the items in the package. As the package savings are being calculated, the amount of savings may be displayed to the user in the window 952.

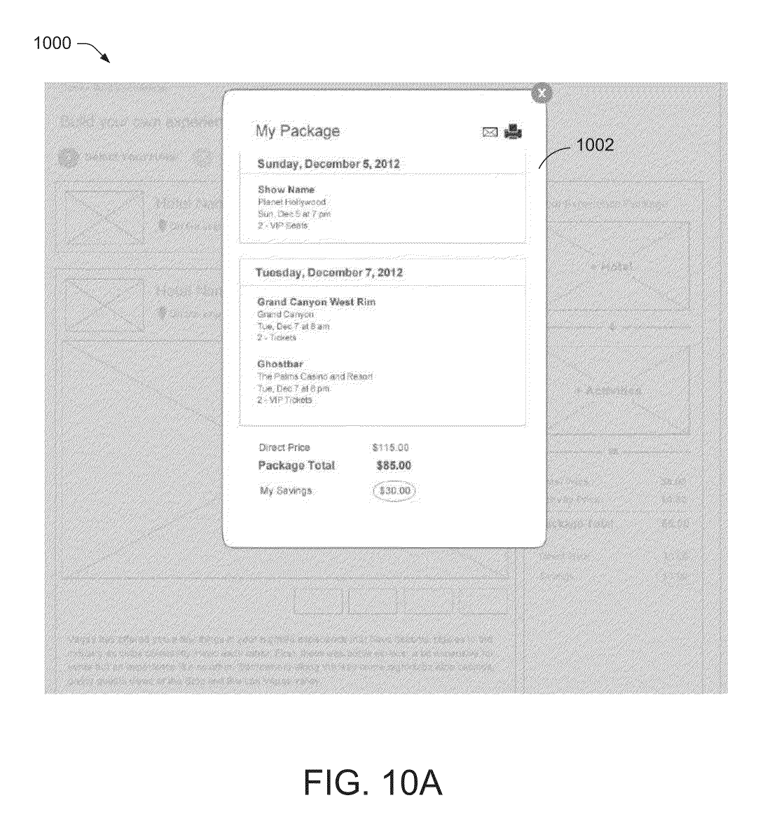

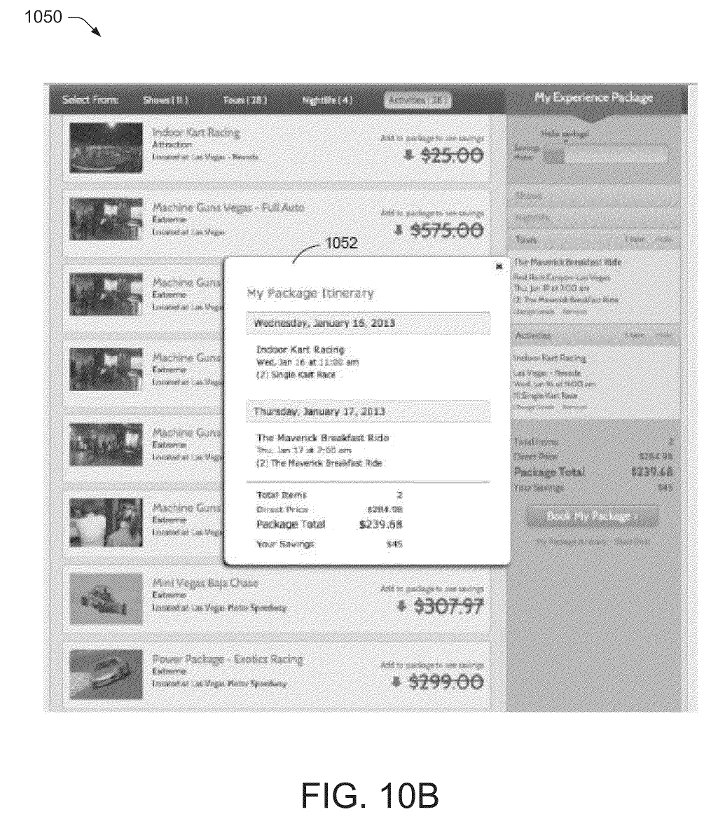

FIGS. 10A-10B are interface diagrams illustrating example user interfaces 1000 and 1050 displaying the contents of a package. User interface 1000 of FIG. 10A may include window 1002 indicating the travel items included in a package, the price of the package, and the savings associated with the package. User interface 1050 of FIG. 10B may similarly include window 1052 indicating the travel items included in the package, the price of the package, and the savings associated with the package.

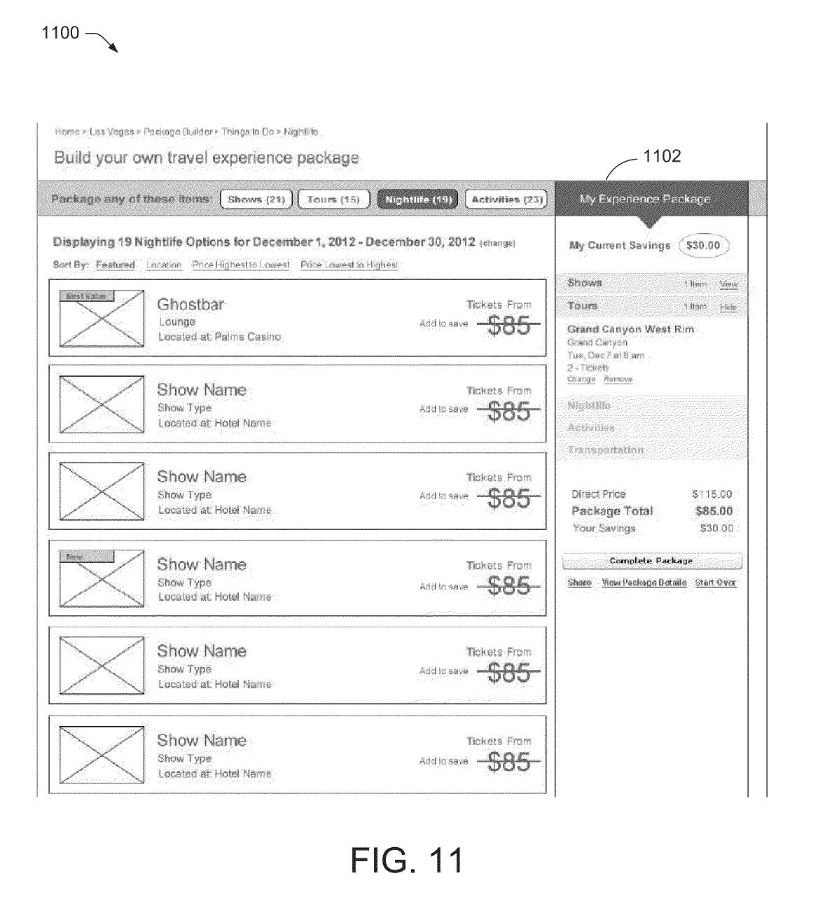

FIG. 11 is an interface diagram illustrating an example user interface 1100 for adding a subsequent item to a package after two travel items have been added to the package. The side portion 1102 may show the travel items currently included in the package, the price associated with the package, and the savings associated with the package.

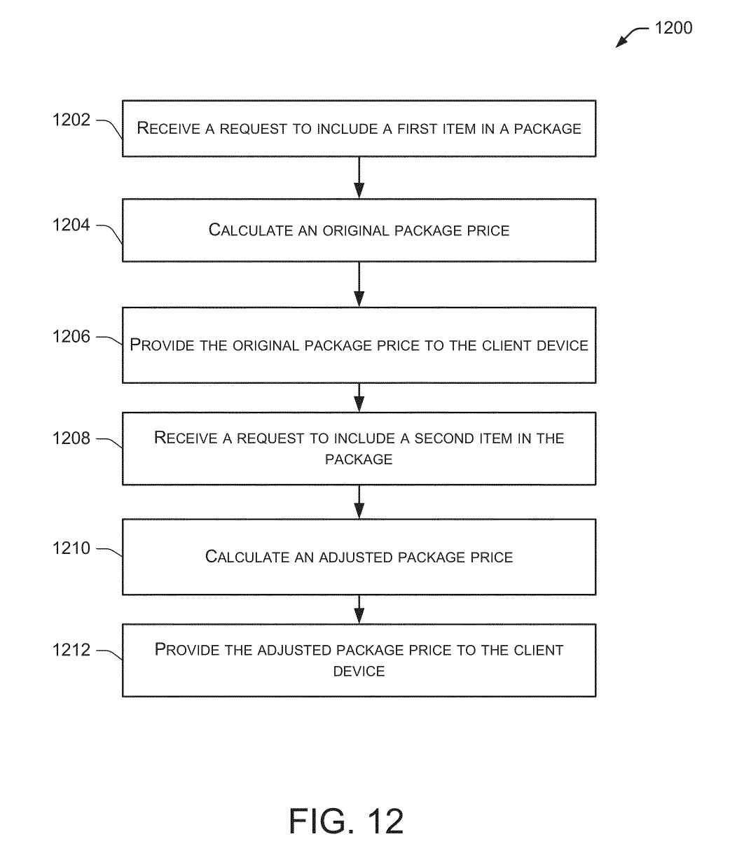

FIG. 12 is a flowchart of an example method 1200 for generating product packages. The method 1200 may be performed using the components of the package builder system 116 shown in FIG. 1.

In operation 1202, the package builder system may receive a request to include a first item in a package. The request may be received over a network from an application running on the client device of the user (e.g., the request may be sent when the user selects the travel item from a list of travel items, such as in FIGS. 4A-4B). The first item may be associated with a particular price (e.g., a retail price).

In operation 1204, the package builder system may calculate an original package price for the package in response to receiving the request to add the first item. In some embodiments, the original package price may be a non-discounted price for the first travel item added to the package (e.g., the retail price of the travel item).

In operation 1206, the original package price may be provided to the client device of the user (e.g., in the side portion 702 of FIG. 7A).

In operation 1208, the package builder system may receive a request from the user to include a second item in the package (e.g., the request may be sent when the user selects the travel item from a list of travel items, such as in FIGS. 7A-7B). The second item may also be associated with a particular price (e.g., a retail price).

In operation 1210, the package builder system may calculate the adjusted package price of the package based on the first item and the second item added to the package in response to the request to add the second item. The adjust package price may be less than the sum of the first price and the second price and may include a discount of the first price and the second price. In some embodiments, the adjust package price may be price that is discounted at a particular rate based on the number of travel items in the package.

In operation 1212, the adjust package price is provided to the client device of the user (e.g., FIGS. 10A-10B). The user may then choose to purchase the package after the user is satisfied with the travel items in the cart or save the package for later viewing and/or purchase (e.g., operation 224 of FIG. 2A). In some embodiments, the user may be allowed to apply a coupon code to the package price for additional savings. In some embodiments, the user may be provided with an option to add details of package itinerary to the user's calendar. In some embodiments, the user may be provided with the ability to share the details of the package with other people (e.g., email, social media, text, etc.). The details of the package can be shared with other people before and/or after the package is purchased. In some embodiments, the package builder system may use the details of the package to determine other items that the user may like, and the user may be provided with a recommendation for those items.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

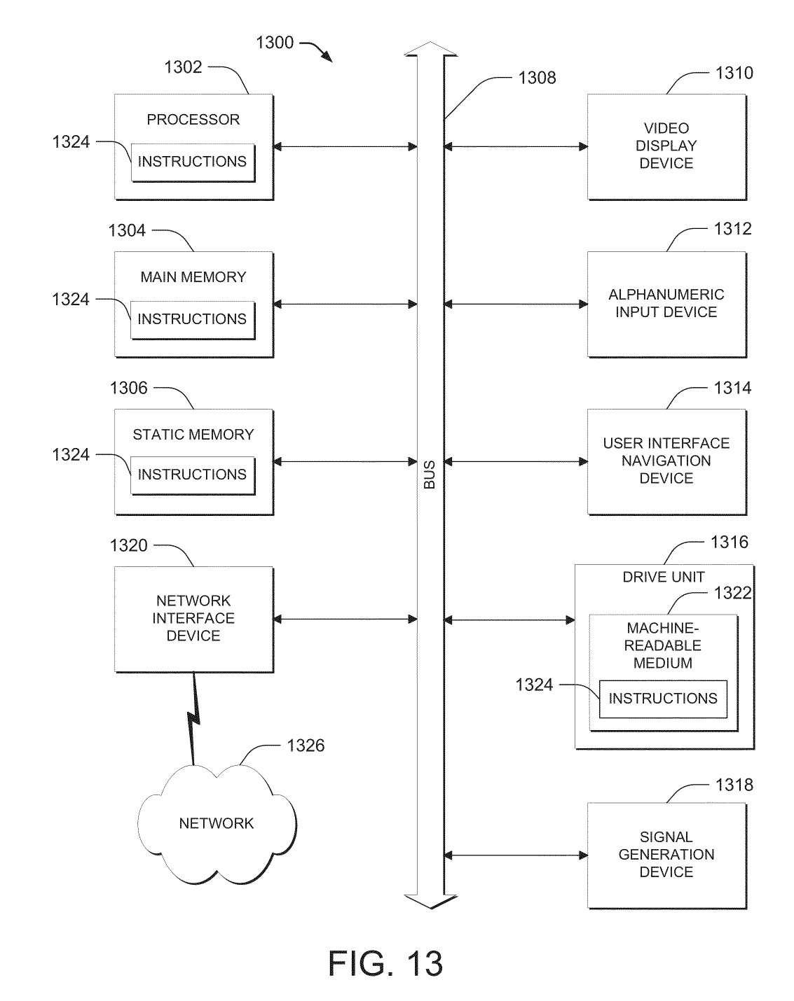

FIG. 13 is a block diagram of a machine in the example form of a computer system 1300 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1300 includes a processor 1302 (e.g., a central processing unit (CPU), a graphics processing unit (GPU) or both), a main memory 1304, and a static memory 1306, which communicate with each other via a bus 1308. Computer system 1300 may further include a video display device 1310 (e.g., a liquid crystal display (LCD) or a cathode ray tube (CRT)). Computer system 1300 also includes an alphanumeric input device 1312 (e.g., a keyboard), a user interface (UI) navigation device 1314 (e.g., a mouse or touch sensitive display), a disk drive unit 1316, a signal generation device 1318 (e.g., a speaker) and a network interface device 1320.

Disk drive unit 1316 includes a machine-readable medium 1322 on which is stored one or more sets of instructions and data structures (e.g., software) 1324 embodying or utilized by any one or more of the methodologies or functions described herein. Instructions 1324 may also reside, completely or at least partially, within main memory 1304, within static memory 1306, and/or within processor 1302 during execution thereof by computer system 1300, main memory 1304 and processor 1302 also constituting machine-readable media.

While machine-readable medium 1322 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 1324 may further be transmitted or received over a communications network 1326 using a transmission medium. Instructions 1324 may be transmitted using network interface device 1320 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving, from a client device, a first request to include a first item in a package, the first item being associated with a first price, the package being purchasable by a user of the client device;
calculating, by a server, an original package price associated with the package in response to receiving the first request, the original package price including the first price of the first item;
providing the original package price to the client device;
receiving a second request to include a second item in the package, the second item being associated with a second price;
calculating, by the server, an adjusted package price in response to receiving the second request, the adjusted package price being less than a sum of the first price and the second price and including a discount of the first price and a discount of the second price; and
providing the adjusted package price to the client device.

2. The method of claim 1, wherein the first item is related to a travel event.

3. The method of claim 1, further comprising:
providing, to the client device, a notification indicating a savings price, the savings price being a difference between the sum and the adjusted package price.

4. The method of claim 1, wherein the first item is from a first supplier and the second item is from a second supplier being different than the first supplier.

5. The method of claim 1, further comprising:
receiving, by the server, first information associated with the first item from a first supplier supplying the first item, the first information including at least one of a first wholesale price of the item that is less than the first price, a suggested retail price, a package price, a discount, an item description, an item photo, a policy associated with the first item, a video, a caption, a product name, a date, a time, and a location.

6. The method of claim 1, wherein the first item is an item relating to at least one of lodging, transportation, a tour, a show, and an activity.

7. The method of claim 1, wherein the first request from the client device includes information relating to at least one of a date, a time, a location, and a preference.

8. A machine-readable storage medium storing instructions which, when executed by one or more processors, cause the one or more processors to perform operations comprising:
receiving, from a client device, a first request to include a first item in a package, the first item being associated with a first price, the package being purchasable by a user of the client device;
calculating an original package price associated with the package in response to receiving the first request, the original package price including the first price of the first item;
providing the original package price to the client device;
receiving a second request to include a second item in the package, the second item being associated with a second price;
calculating an adjusted package price in response to receiving the second request, the adjusted package price being less than a sum of the first price and the second price and including a discount of the first price and a discount of the second price; and
providing the adjusted package price to the client device.

9. The machine-readable storage medium of claim 8, wherein the first item is related to a travel event.

10. The machine-readable storage medium of claim 8, wherein the instructions cause the one or more processors to perform further operations comprising:
providing, to the client device, a notification indicating a savings price, the savings price being a difference between the sum and the adjusted package price.

11. The machine-readable storage medium of claim 8, wherein the first item is from a first supplier and the second item is from a second supplier being different than the first supplier.

12. The machine-readable storage medium of claim 8, wherein the instructions cause the one or more processors to perform further operations comprising:
receiving first information associated with the first item from a first supplier supplying the first item, the first information including at least one of a first wholesale price of the item that is less than the first price, a suggested retail price, a package price, a discount, an item description, an item photo, a policy associated with the first item, a video, a caption, a product name, a date, a time, and a location.

13. The machine-readable storage medium of claim 8, wherein the first request from the client device includes information relating to at least one of a date, a time, a location, and a preference.

14. A system comprising:
a hardware-implemented input module configured to:
receive, from a client device, a first request to include a first item in a package, the first item being associated with a first price, the package being purchasable by a user of the client device, and
receive a second request to include a second item in the package, the second item being associated with a second price;
a hardware-implemented package pricing module configured to:
calculate an original package price associated with the package in response to receiving the first request, the original package price including the first price of the first item, and
calculate an adjusted package price in response to receiving the second request, the adjusted package price being less than a sum of the first price and the second price and including a discount of the first price and a discount of the second price; and
a hardware implemented display module configured to:
provide the original package price to the client device, and
provide the adjusted package price to the client device.

15. The system of claim 14, wherein the first item is related to a travel event.

16. The system of claim 14, wherein the hardware implemented display module is further configured to provide, to the client device, a notification indicating a savings price, the savings price being a difference between the sum and the adjusted package price.

17. The system of claim 14, wherein the first item is from a first supplier and the second item is from a second supplier being different than the first supplier.

18. The system of claim 14, wherein the hardware implemented input module is further configured to receive first information associated with the first item from a first supplier supplying the first item, the first information including at least one of a first wholesale price of the item that is less than the first price, a suggested retail price, a package price, a discount, an item description, an item photo, a policy associated with the first item, a video, a caption, a product name, a date, a time, and a location.

19. The system of claim 14, wherein the first item is an item relating to at least one of lodging, transportation, a tour, a show, and an activity.

20. The system of claim 14, wherein the first request from the client device includes information relating to at least one of a date, a time, a location, and a preference.
